(19) United States
(12) Patent Application Publication
(10) Pub. No.: US 2016/0047658 A1
(43) Pub. Date: Feb. 18, 2016

(54) MAP DATA STORAGE DEVICE, MAP DATA PROCESSING DEVICE, AND MAP DATA UPDATING SYSTEM

(71) Applicant: DENSO CORPORATION, Kariya-ciyt, Aichi-pref (JP)

(72) Inventors: Yuuji NISHIDE, Kariya-city (JP); Takamitsu SUZUKI, Okazaki-city (JP)

(73) Assignee: DENSO CORPORATION, Kariya-ciyt, Aichi-pref (JP)

(21) Appl. No.: 14/783,259

(22) PCT Filed: Mar. 21, 2014
(86) PCT No.: PCT/JP2014/001661

§ 371 Date: Oct. 8, 2015

(30) Foreign Application Priority Data
Apr. 16, 2013 (JP) 2013-085996

(51) Int. Cl. G01C 21/26

(52) U.S. Cl. CPC G01C 21/26

(57) ABSTRACT

A map data updating system includes a first map data storage storing a first version of update-directed data and a first version of update-undirected data in different partitions, a second map data storage storing an image file of a second version of the update-directed data and an image file of a second version of the update-undirected data, and an update processing device that reads the image file of the second version of the update-directed data from the second map data storage device and restores the read image file of the second version of the update-directed data and overwrites the partition storing the first version of the update-directed data.

### CROSS REFERENCE TO RELATED APPLICATION

The present application is based on Japanese Patent Application No. 2013-85996 filed on Apr. 16, 2013, the disclosure of which is incorporated herein by reference.

### TECHNICAL FIELD

The present disclosure relates to a map data storage device, a map data processing device including the map data storage device, and a map data updating system to update map data for the map data storage device.

### BACKGROUND ART

A new road is constructed every day. An existing road may be removed. There is a prior-art technology that updates part of road map data in response to an increase or decrease in actual roads (e.g., patent literature 1). According to patent literature 1, map data is stored in a storage device included in a vehicular navigation unit. A map publisher successively creates update map data that is wirelessly delivered to the vehicular navigation unit.

### PRIOR ART LITERATURES

### Patent Literature

Patent Literature 1: Japanese Patent No. 4682089

### SUMMARY OF INVENTION

The map data, even update data, requires a large amount of resource. The amount of data bottlenecks the communication when update data is delivered wirelessly.

Generally, the map data also contains facility data or other data than road data. The most up-to-date road preferentially needs to be drawn in the map. Therefore, the road data preferentially needs to be updated. The road data is also needed to compute routes. Also in this regard, the road data preferentially needs to be updated. However, the facility data needs to be updated less preferentially than the road data.

Update data for the road data may be directed to update using wireless communication. Update data for the facility data may not be directed to update using wireless communication. According to types of data, the map data may be classified into update-directed data and update-undirected data.

An in-vehicle device may wirelessly acquire new update-directed data (hereinafter referred to as update-directed difference data) not contained in the map data stored in the storage device of the vehicular navigation unit. However, the hitherto stored map data may not be updated with the acquired update-directed difference data. In this case, both versions of data are stored concurrently.

When map data is updated (to create a new map) in a country where a legal system requires governmental approval of the updated map data by law, the update-directed difference data is stored as is. In this case, a process to use the map data such as displaying a map or searching for a route necessitates performing an overlap process that allows the update-directed difference data to overlap update-directed data (the same type of data as the update-directed difference data) contained in the map data.

The update-directed difference data may be delivered not only once but also successively such as monthly. The update-directed difference data delivered successively is all stored directly. When several pieces of update-directed difference data are stored, all the pieces of update-directed difference data need to be overlapped with the update-directed data each time the map data is used. This decreases a processing speed.

For addressing this, the update-directed data stored in the storage device of the vehicular navigation unit may be replaced with authorized new data, namely, new update-directed data that reflects the contents of the update-directed difference data. This eliminates the need to perform the overlap process during a process to use the map data.

The inventors studied three methods as follows to change the update-directed data to new data.

The first method follows. A map publisher successively creates new map data. The map publisher receives authorization each time new map data is created. The first method extracts update-directed data from the most up-to-date map data created by the map publisher and uses the extracted update-directed data to rewrite update-directed data for the map data stored in the storage device of the vehicular navigation unit. A rewrite operation requires wired connection between the storage device storing the most up-to-date map data and the storage device of the vehicular navigation unit.

However, the first method involves the following disadvantage. The update-directed data contains many files. The method is supposed to extract files one by one corresponding to the update-directed data from the most up-to-date map data and rewrite files one by one corresponding to the update-directed data stored in the storage device of the vehicular navigation unit. In such a case, a very long time may be required to complete the rewrite operation.

The second method follows. The second method replaces the entire map data stored in the storage device of the vehicular navigation unit with the most up-to-date map data created by the map publisher. The second method can rewrite the entire map data containing many files as one image file unlike the first method that rewrites files one by one. The process time is much shorter than the first method. A rewrite operation according to the second method also requires wired connection between the storage device storing the most up-to-date map data and the storage device of the vehicular navigation unit.

However, the second method involves the following disadvantage. Creating new map data is costly. In many cases, updating the map data is charged. Only update-directed difference data is wirelessly delivered. The update-undirected data is not delivered. A user is considered to make a contract to pay a renewal charge for only the update-directed difference data. Despite, the second method updates the entire map data containing the update-undirected data. The user might be obliged to pay a renewal charge for even the update-undirected data to which the contract is inapplicable.

The third method follows. As described in the second method, a user having a contract for delivery of the update-directed difference data does not make a contract to pay a charge to update the update-undirected data.

According to the third method, the map publisher creates map data that updates only the update-directed data and does not update the update-undirected data. This map data is hereinafter referred to as the nearly most up-to-date map data. The third method uses the nearly most up-to-date map data as a whole to rewrite the entire map data stored in the storage device of the vehicular navigation unit. Similarly to the first and second methods, a rewrite operation according to the third method also requires wired connection between the storage device storing the most up-to-date map data and the storage device of the vehicular navigation unit.

Similarly to the second method, the third method can also generate an image file to shorten the processing time because the entire map data is rewritten. However, the third method involves the following disadvantage. To comply with the third method, the map publisher must create the nearly most up-to-date map data in addition to map data whose update-directed data and update-undirected data are most up-to-date. Map creation costs may increase.

The present disclosure has been made in consideration of the foregoing. It is an object of the disclosure to provide a map data storage device, a map data processing device, and a map data updating system capable of shortening the process time to update map data and suppressing cost burden on a user or a map publisher.

In a first example of the disclosure, a map data storage device storing map data comprises a plurality of partitions. The map data includes: update-directed data containing at least road data; and update-undirected data. The update-directed data and the update-undirected data are stored in different partitions.

In the map data storage device stores, because the update-directed data and update-undirected data included in the map data are stored in the different partitions, the update-directed data can be updated at a time by rewriting the entire partition that stores the update-directed data. This can shorten the time to update the update-directed data.

Moreover, the data to be updated can be only the update-directed data. This reduces the user's costs.

Moreover, as the most up-to-date update-directed data used to rewrite the whole of the update-directed data, the update-directed data in the most up-to-date map data can be used, where the most up-to-date map data itself is supposed to be created by its nature. Therefore, the map publisher can suppress an increase in the map creation cost because the map publisher need not create map data only used to rewrite the update-directed data.

In a second example of the present disclosure, a map data processing device comprises: a first map data storage device storing map data that includes a first version of update-directed data and a first version of update-undirected data, wherein the update-directed data contains at least road data, wherein the first version of the update-directed data and the first version of the update-undirected data are stored in different partitions; a wireless communicator that performs wireless communication with outside; a difference data storage processing portion that with the wireless communicator, successively receives update-directed difference data serving as update data for the update-directed data, and stores the update-directed difference data in the partition of the first map data storage device where the update-directed data is stored; an overlap processing portion that performs an overlap process as requested by a process that uses the map data, wherein the overlap process overlaps the update-directed difference data and the update-directed data stored in the first map data storage device; and an update processing portion that reads an image file of a second version of the update-directed data newer than the first version from a second map data storage device storing the image file of the second version of the update-directed data and an image file of a second version of the update-undirected data, deletes the first version of the update-directed data and the update-directed difference data stored in the first map data storage device, and restores the read image file of the second version of the update-directed data to the partition where the first version of the update-directed data was stored.

In a third example of the present disclosure, a map data updating system comprises: a first map data storage device storing map data that includes a first version of update-directed data and a first version of update-undirected data, wherein the update-directed data contains at least road data, wherein the first version of the update-directed data and the first version of the update-undirected data are stored in different partitions; a second map data storage device storing an image file of a second version of the update-directed data and an image file of a second version of the update-undirected data, wherein the second version is newer than the first version; and an update processing device that reads an image file of the second version of the update-directed data from the second map data storage device, and restores the read image file of the second version of the update-directed data and overwrites the partition storing the first version of the update-directed data.

### BRIEF DESCRIPTION OF DRAWINGS

FIG. 1 is a configuration diagram illustrating a map data updating system,

FIG. 2 is a diagram illustrating a storage area in a storage portion and a storage area for map data;

FIG. 3 is a diagram illustrating storage contents of a storage area in USB memory;

FIG. 4 is a diagram illustrating processes of a difference data storage processing portion and an update processing portion in FIG. 1;

FIG. 5 is a diagram illustrating a first comparative example; and

FIG. 6 is a diagram illustrating a second comparative example.

### EMBODIMENTS FOR CARRYING OUT INVENTION

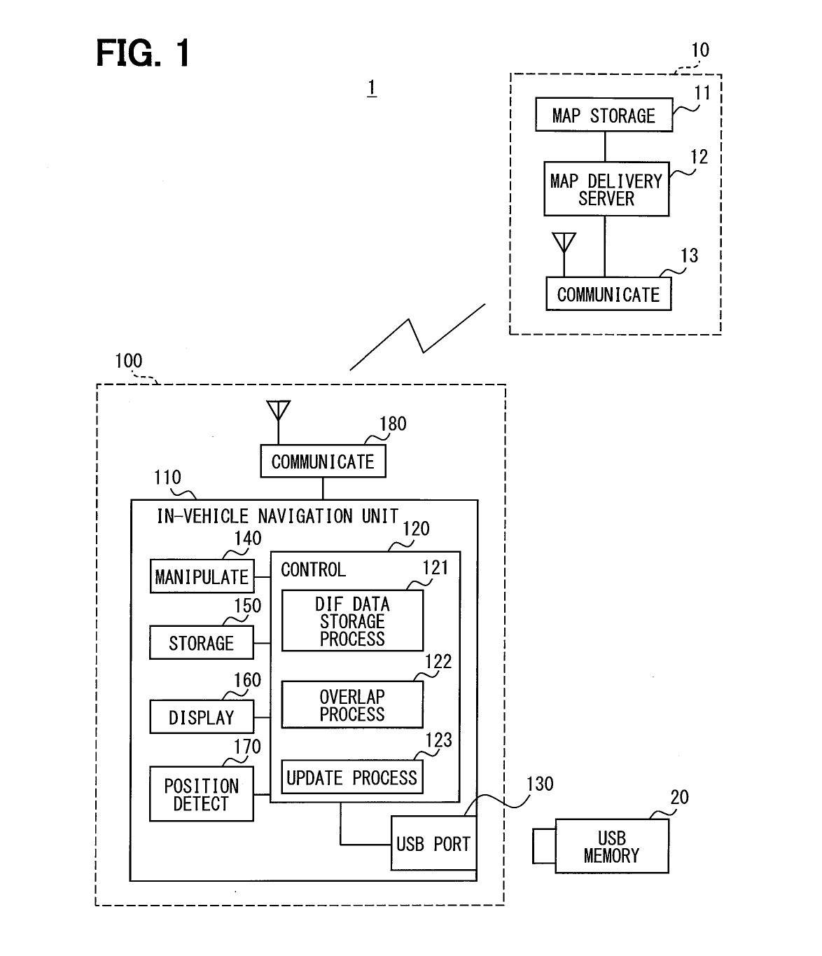

Embodiments of the present disclosure will be described with reference to the accompanying drawings. As illustrated in FIG. 1, a map data updating system 1 according to the embodiment includes a center device 10, USB memory 20, and an in-vehicle device 100.

The in-vehicle device 100 will be described first. The in-vehicle device 100 corresponds to an example of a map data processing device. The in-vehicle device 100 includes an in-vehicle navigation unit 110, a position detector 170, and a wireless communicator 180. The in-vehicle navigation unit 110 corresponds to an example of an update processing device. The in-vehicle navigation unit 110 includes a control portion 120, a USB port 130, a manipulation portion 140, a storage portion 150, and a display portion 160.

A user manipulates the manipulation portion 140 for various input manipulations. The manipulation portion 140 represents a mechanical switch placed at a position accessible from a driver or a touch switch overlapped with a display surface of the display portion 160.

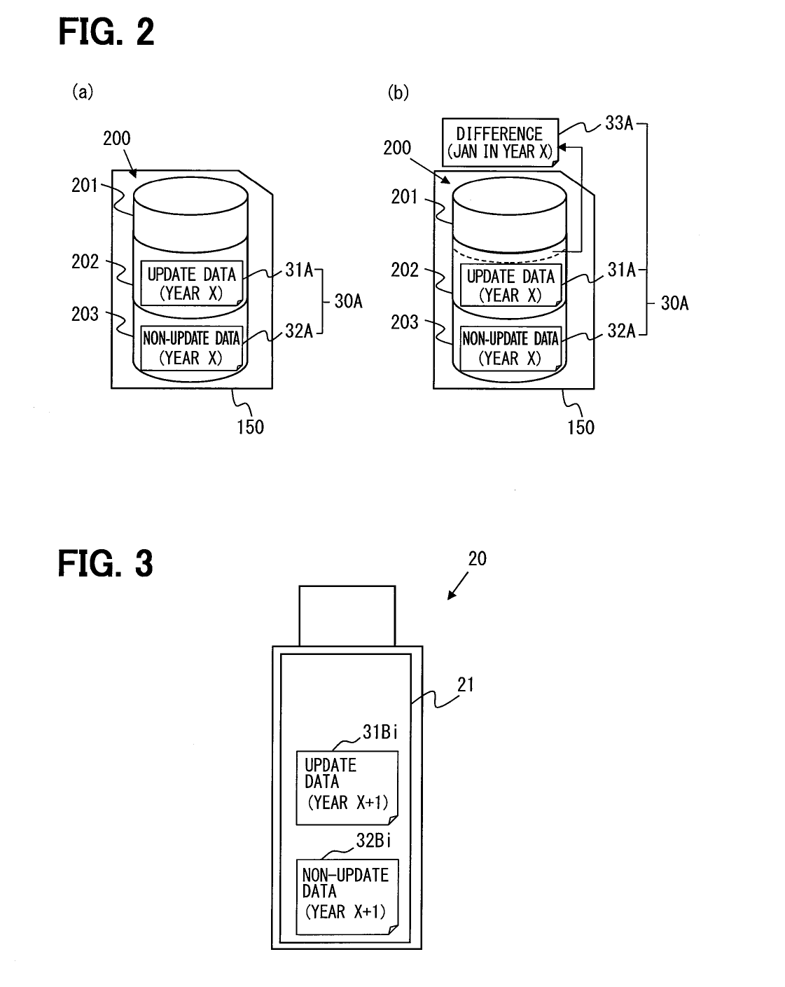

The storage portion 150 corresponds to an example of a first map data storage device. The storage portion 150 represents a rewritable storage medium such as an SD card. The storage portion 150 stores map data 30A illustrated in FIG. 2. Alphabetic suffix A in map data 30A denotes a version. The representation of map data 30 without suffix is used if there is no need for distinction between versions.

FIG. 2 also illustrates a logical structure of a storage area 200 in the storage portion 150. The storage area 200 of the storage portion 150 is divided into three partitions, namely first through third partitions 201, 202, and 203.

The first partition 201 stores a program or a dictionary. The second partition 202 stores update-directed data 31A. The third partition 203 stores update-undirected data 32A. Alphabetic suffix A in update-directed data 31A and update-undirected data 32A denotes a version. The representation of the update-directed data 31 and the update-undirected data 32 without suffix is used if there is no need for distinction between versions.

The map data 30 includes the update-directed data 31 and the update-undirected data 32. As illustrated in FIG. 2(b), update-directed difference data 33A is also contained in the map data 30. Alphabetic suffix A in update-directed difference data 33A denotes the same as used for the reference numerals 30, 31, and 32.

The example in FIG. 2 uses three partitions. However, the number of partitions is not limited to three. At least the update-directed data 31 and the update-undirected data 32 just need to be stored in different partitions.

The update-directed data 31 contains a contract between user and provider to enable update for new data during a specified period (such as two years). For example, road data corresponds to the update-directed data 31. New data for the update-directed data 31 corresponds to the update-directed difference data 33 and is delivered wirelessly.

The update-directed data 32 is not updated to a new version. Facility data is an example. Several types of map data are available. A predetermined criterion is provided to determine which type of data corresponds to the update-directed data 31 or the update-undirected data 32, in consideration of various situations such as importance of data or limitations on communication traffic. All types of data are not provided as the update-directed data 31 and some types of data are provided as the update-undirected data 32. The reason follows. If all types of data are to be updated, too large an amount of data needs to be updated, unfavorably affecting the communication traffic.

As will be described in detail later, an overlap process is performed to allow the update-directed data 31 and the update-directed difference data 33 to overlap with each other as needed to draw a map without updating the update-directed data 31 itself.

The update-directed difference data 33 is successively delivered from the center device 10. A user of the in-vehicle device 100 makes a contract to prepay a specified charge in order to receive the right to successively receive the update-directed difference data 33. The charge to be paid corresponds to update data for the update-directed data 31 and does not cover a charge to acquire update data for the update-undirected data 32. An optional charge (contract) is needed on demand to acquire update data for the update-undirected data 32. The map data includes the update-directed difference data 33 and the update-undirected data 32. According to the embodiment, the user can make a contract by paying a specified charge to receive the right to successively receive the update-directed difference data 33 during a specified period. The user needs to pay an optionally specified charge as needed to acquire update data for the update-undirected data 32. The distinction between data types can protect the user from unintended payment when data is updated. The embodiment uses the distinction between update-directed data and update-undirected data but is not limited thereto.

The update-directed difference data 33 belongs to the update-directed data 31. The update-directed difference data 33 corresponds to newly updated data after the update-directed data 31 is generated (or after the most recent update-directed difference data 33 is generated if the update-directed difference data 33 is already generated). Similarly to the update-directed data 31, the update-directed difference data 33 is also stored in the second partition 202. The first partition 201 may first store the update-directed difference data 33 received from the center device 10. The second partition 202 may store the update-directed difference data 33 whose format is converted into the same format as the update-directed data 31.

The description returns to FIG. 1. The display portion 160 is placed at a position visually identifiable from a driver in a vehicle compartment and displays a map around the present place. The position detector 170 includes a receiver for a satellite positioning system such as GPS (Global Positioning System) for detecting a position of the device based on an acceleration sensor, a gyroscope, and a radio wave from a satellite (all compliant with widely known technologies). The position detector 170 successively detects the current position.

The wireless communicator 180 is communicable with a wireless communicator 13 in the center device 10. The wireless communicator 180 connects with a wireless network for mobile telephones to perform communication.

The control portion 120 is connected to the manipulation portion 140, the storage portion 150, the display portion 160, and the USB port 130. The control portion 120 includes a computer with a CPU, ROM, and RAM. The CPU uses a temporary storage function of the RAM and performs a program stored in the ROM to provide functions of a difference data storage processing portion 121, an overlap processing portion 122, and an update processing portion 123. The CPU also provides functions such as a router search function, a route guidance function, and a map drawing function provided by a publicly known automobile navigation system.

The update-directed difference data 33 is successively delivered from the center device 10. The wireless communicator 180 in the in-vehicle device 100 acquires the update-directed difference data 33. The difference data storage processing portion 121 acquires the update-directed difference data 33 from the wireless communicator 180 and stores the update-directed difference data 33 in the second partition 202 in the storage portion 150.

The overlap processing portion 122 performs a process to overlap the update-directed data 31 and the update-directed difference data 33 stored in the storage portion 150 as requested by a process that uses the map data 30. Processes that uses the map data 30 include a map drawing process and a route search process that causes the display portion 160 to display a range of map determined by the map scale based on reference points such as a current place, a departure place, and a destination.

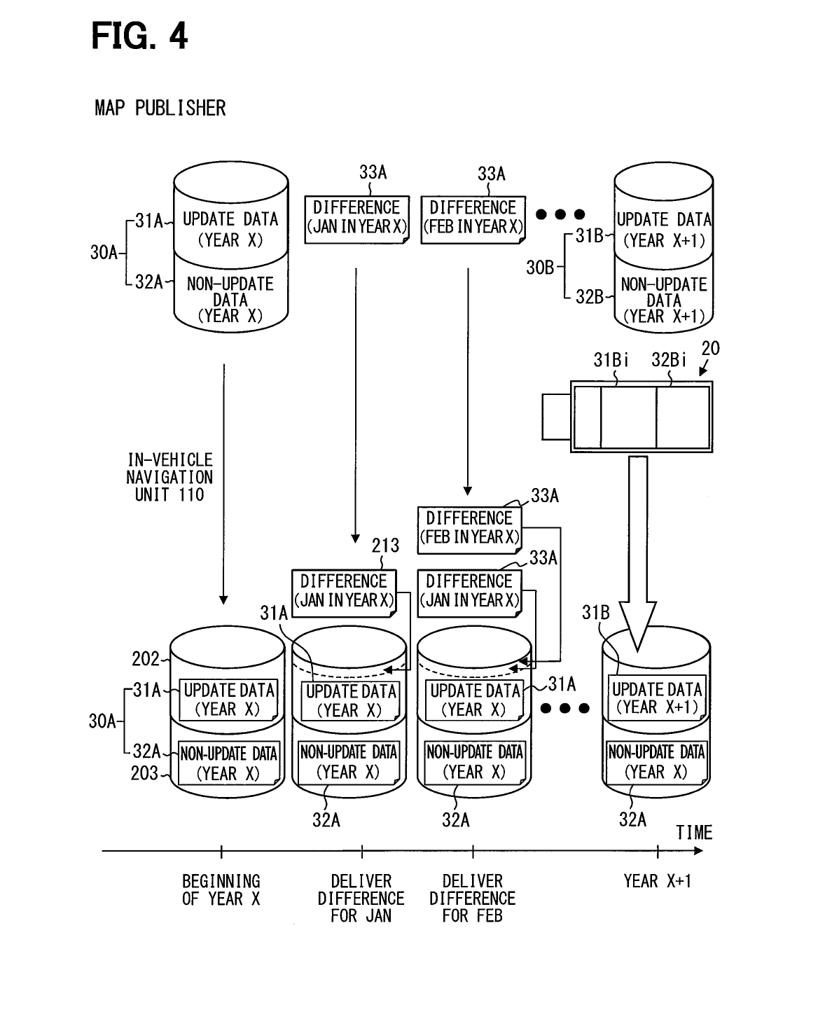

The update processing portion 123 performs a process that updates a storage content of the second partition 202 to a new version of the update-directed data 31. The update processing portion 123 acquires the new version of the update-directed data 31 from the USB memory 20 via the USB port 130. The process of the update processing portion 123 will be described later with reference to FIG. 4.

The configuration of the center device 10 will be described. The center device 10 includes a map storage device 11, a map delivery server 12, and the wireless communicator 13. The map storage device 11 stores the update-directed difference data 33 to be delivered from the wireless communicator 13.

The map delivery server 12 acquires the update-directed difference data 33 from the map storage device 11. The wireless communicator 13 of the map delivery server 12 delivers the update-directed difference data 33 to the in-vehicle device 100. The wireless communicator 13 is communicable with the wireless communicator 180 in the in-vehicle device 100.

As illustrated in FIG. 3, the storage area 21 in the USB memory 20 stores most up-to-date update-directed data 31B and update-undirected data 32B (a version in year x+1) created by the map publisher. Update-directed data 31B and update-undirected data 32B are stored in the form of image files 31Bi and 32Bi, respectively. In addition, an image file is used to store data in the first partition 201 in the storage portion 150. The USB memory 20 corresponds to an example of a second map data storage device.

FIG. 4 illustrates processes of the difference data storage processing portion 121 and the update processing portion 123 in FIG. 1. The lower part of FIG. 4 shows the map data 30 stored in the storage area 200 in the storage portion 150 in the in-vehicle navigation unit 110. The upper part of FIG. 4 shows the map data 30 created by the map publisher.

For the purpose of illustration, FIG. 4 assumes an example in which a vehicle equipped with the in-vehicle navigation unit 110 is sold at the beginning of year x and the storage area 200 in the storage portion 150 stores map data 30A in the most up-to-date version (version of year x) at the time, namely, update-directed data 31A and update-undirected data 32A in the version of year x. Update-directed data 31A and update-undirected data 32A are stored in the different partitions 202 and 203.

In the example in FIG. 4, the map publisher creates a new version of the map data 30 once a year. The map publisher creates update-directed difference data 33A illustrated in FIG. 2 once a month.

The map storage device 11 in the center device 10 stores monthly-created update-directed difference data 33A. The map delivery server 12 in the center device 10 controls the map storage device 11 and the wireless communicator 13 so that the center device 10 delivers update-directed difference data 33A to the in-vehicle device 100.

The in-vehicle device 100 receives update-directed difference data 33A from the wireless communicator 180. Update-directed difference data 33A received by the wireless communicator 180 is sent to the in-vehicle navigation unit 111. A process of the difference data storage processing portion 121 stores update-directed difference data 33A in the second partition 202 corresponding to delivery time points of difference data for January and February as illustrated in FIG. 4.

Update-directed difference data 33A does not update update-directed data 31A. Update-directed difference data 33A is just stored in the second partition 202 that also stores update-directed data 31A.

Though not illustrated in FIG. 4, update-directed difference data 33A is also created for March and April. The in-vehicle device 100 receives monthly-created update-directed difference data 33A from the center device 10 and stores update-directed difference data 33A in the second partition 202 in the storage portion 150.

The overlap processing portion 122 performs a process to overlap update-directed data 31A and update-directed difference data 33A stored in the storage portion 150 as requested by a process that uses the map data 30. The overlap process allows all the pieces of update-directed difference data 33A to overlap with update-directed data 31A if update-directed difference data 33A corresponding to several months is available in an area determined by the process that uses the map data 30. Increasing update-directed difference data 33A to be overlapped also increases the processing time required for overlapping. The result is to increase the processing time or to decrease the processing speed.

To solve this, the map data updating system 1 according to the embodiment uses the most up-to-date map data (map data 30B in the version of year x+1 in FIG. 4) created by the map publisher to replace update-directed data (year x) 31A stored in the storage portion 150 in the in-vehicle navigation unit 110 with most up-to-date update-directed data 31B.

The replacement process will be described. The map publisher creates map data 30B in the version of year x+1 to be used for an in-vehicle device that will be sold in year x+1. Map data 30B is divided into update-directed data (year x+1) 31B and update-undirected data 32B. According to the embodiment, data 31B and 32B are stored as image files 31Bi and 32Bi in the USB memory 20. The USB memory 20 is placed at a car dealer.

A user of the vehicle equipped with the in-vehicle device 100 visits the car dealer where the USB memory 20 is placed. The user borrows the USB memory 20 and inserts it into the USB port 130.

The process of the update processing portion 123 follows. The update processing portion 123 copies image file 31Bi of update-directed data (year x+1) 31B stored in the USB memory 20 to the second partition 202 in the storage portion 150 and restores the image file 31Bi. Copying image file 31Bi is faster than copying files one by one.

The image file uses the entire partition as one file. According to the embodiment, the storage area 200 is divided into partitions 201 through 203. Update-directed data 31A (to be replaced) and update-undirected data 32A (not to be replaced) are stored in the respective partitions 202 and 203.

Copying the image files deletes update-directed data (year x) 31A and update-directed difference data 33A stored in the second partition 202 in the storage portion 150. However, update-directed data (year x+1) 31B contains update-directed data (year x) 31A and all the update-directed difference data for January to December. Thus, update-directed difference data 33A stored before image file 31Bi is copied becomes redundant. Update-directed difference data 33A can be deleted safely. Update-directed difference data 33A is stored in the same partition 202 as update-directed data (year x) 31A. Replacing the data with update-directed data (year x+1) 31B can simultaneously deletes obsolete update-directed difference data 33A.

The USB memory 20 stores not only image file 31Bi of update-directed data 31B but also image file 32Bi of update-undirected data 32B and image files of data stored in the first partition 201 in the storage portion 150. The embodiment may perform a process (overall update process) that replaces all data in the first through third partitions 201 through 203 with the most up-to-date data in addition to the process that replaces only the storage content of the second partition 202. If a user is allowed to select any one of the processes based on switch manipulation for example, two types of replacement processes are available using the single USB memory 20.

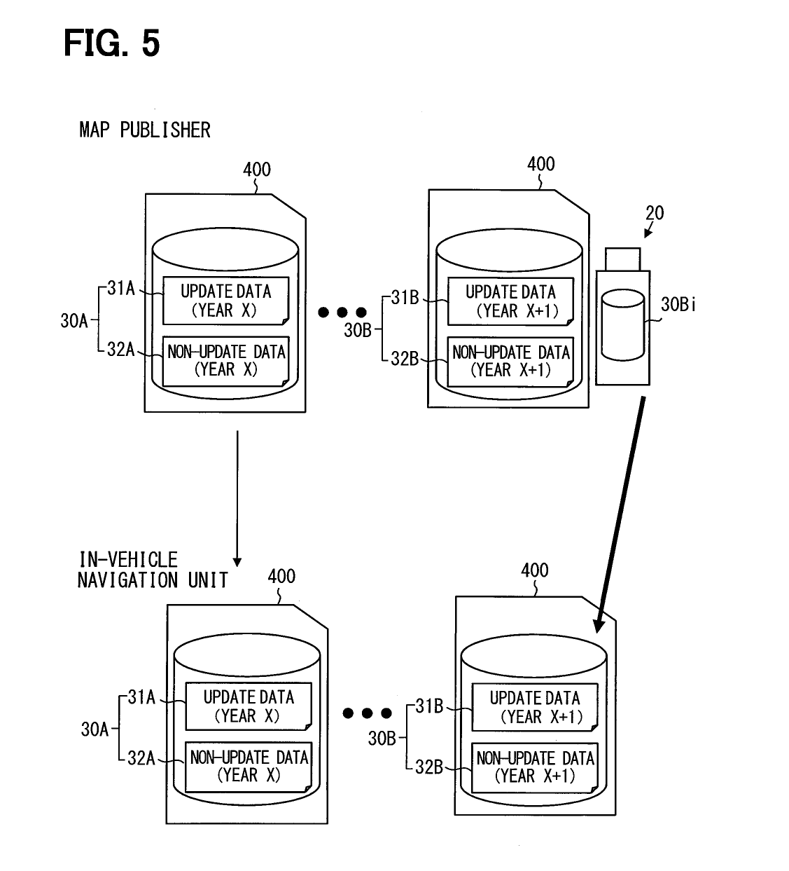

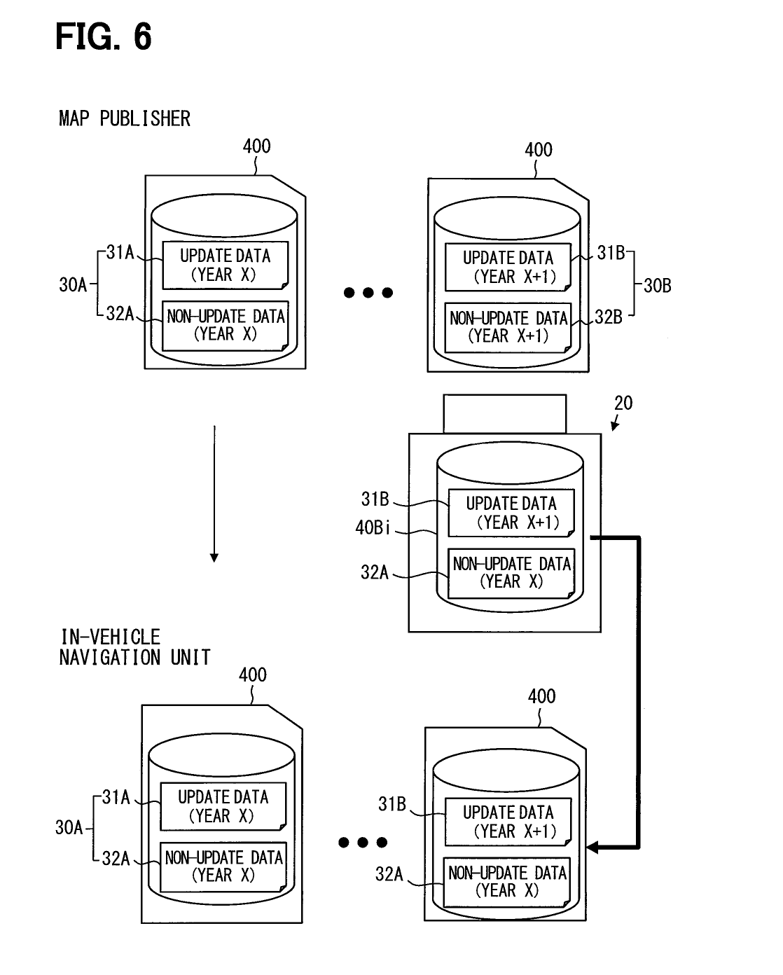

The following describes two comparative examples in comparison with the embodiment in order to describe technical effects of the embodiment. FIG. 5 illustrates the first comparative example. FIG. 6 illustrates the second comparative example.

According to the first comparative example, the storage area 200 is not divided into partitions. Update-directed data (year x) 31A and update-undirected data (year x) 32A are stored in the same partition to generate the map data 30 that is then stored in an SD card 400. The SD card 400 is installed in the in-vehicle navigation unit 110.

A year later, map data 30B is created to contain update-directed data (year x+1) 31B and update-undirected data (year x+1) 32B and is stored in an SD card 410. Similarly to year x, update-directed data (year x+1) 31B and update-undirected data (year x+1) 32B are stored in one partition. The USB memory 20 stores image file 30Bi of map data 30B.

Image file 30Bi of map data 30B stored in the USB memory 20 may be used to update map data 30A in the SD card 400 installed in the in-vehicle navigation unit 110. In this case, as illustrated in FIG. 5, update-directed data (year x) 31A is replaced with update-directed data (year x+1) 31B. In addition, update-undirected data (year x) 32A is replaced with update-undirected data (year x+1) 32B.

The user must pay a charge to acquire the update-undirected data 32 because the update-undirected data 32 is also replaced. However, the user agrees to pay for the update-directed data 31 only.

The first comparative example replaces the update-undirected data 32 whose payment the user does not agree. The user is billed for the charge to acquire the update-undirected data 32.

By contrast, the embodiment does not update update-undirected data 32A (FIG. 4). The user is not billed for the charge to acquire the update-undirected data 32.

The USB memory 20 may store the map data 30 that is not converted into an image file. In this case, update-directed data (year x+1) 31B contains files. The files are extracted one by one from the USB memory 20 to individually rewrite files contained in update-directed data (year x) 31A in the SD card 400 installed in the in-vehicle navigation unit 110.

However, update-directed data 31A contains a large number of files. Individually rewriting files requires a very long time to complete the rewriting. By contrast, the embodiment copies an image file and shortens the time to complete the rewriting.

The second comparative example will be described with reference to FIG. 6. The second comparative example does not divide the storage area 200 into partitions, either. Similarly to the first comparative example, the map publisher stores map data 30A in one partition of the SD card 400 in year x. The SD card 400 is installed in the in-vehicle navigation unit 110.

A difference from the first comparative example lies in map data created in year x+1. The second comparative example generates map data 30B containing update-directed data 31B and update-undirected data 32B both in the version of year x+1. In addition, the second comparative example also stores image file 40Bi of nearly most up-to-date map data in the USB memory 20. The nearly most up-to-date map data contains update-directed data 31B in the version of year x+1 and update-undirected data 32A in the version of year x.

The USB memory 20 is used to replace map data 30A in the SD card 400 in the in-vehicle navigation unit 110. The storage content of the SD card 400 in the in-vehicle navigation unit 110 is rewritten to the map data containing update-directed data (year x+1) 31B and update-undirected data (year x) 32A. Unlike the first comparative example, the user is not billed for the charge to acquire the update-undirected data 32 whose payment the user does not agree. Copying an image file does not increase the time required for the rewriting.

However, the second comparative example needs to generate additional map data for the update in addition to map data 30B which is to be newly installed on the in-vehicle navigation unit 110. This increases the map publisher's costs to create maps.

By contrast, the embodiment can update only update-directed data (year x+1) 31B using map data 30B which is to be newly installed on the in-vehicle navigation unit 110. The embodiment can suppress the map publisher's costs to create maps.

According to the embodiment, the different partitions 202 and 203 store the update-directed data 31 and the update-undirected data 32 contained in the map data 30. Thus, in order to update the update-directed data 31 at a time, the whole of the partition 202 storing the update-directed data 31 just needs to be rewritten. This can shorten the time to update the update-directed data 31.

Moreover, only the update-directed data 31 needs to be updated. The user's costs can be reduced.

Moreover, as the most up-to-date update-directed data used to rewrite the whole of the update-directed data, the update-directed data in the most up-to-date map data can be used, where the most up-to-date map data itself is supposed to be created by its nature. Therefore, the map publisher can suppress an increase in the map creation cost because the map publisher need not create map data only used to rewrite the update-directed data 31.

While there has been described the embodiments of the disclosure, the disclosure is not limited to the embodiments. The disclosure also includes the following embodiment and other embodiments variously modified within the spirit and scope of the disclosure.

For example, the above embodiment updates data by inserting the USB memory 20 into the USB port 130 provided for the in-vehicle navigation unit 110. Alternatively, a storage medium to store the map data 30 may be removed from the in-vehicle navigation unit 110 and may be moved to a device different from the in-vehicle navigation unit 110 to update the data (modification 1).

The storage medium to store the map data 30 need not be an SD card but may be replaced with other types of flash memory (modification 2) or a hard disk (modification 3).

What is claimed is:

1. (canceled)

2. A map data processing device comprising:
a first map data storage device used in a vehicle and storing map data that includes a first version of update-directed data and a first version of update-undirected data, wherein the update-directed data contains at least road data, wherein the first version of the update-directed data and the first version of the update-undirected data, respectively, are stored in a first partition and a second partition of the first map data storage device, wherein the first partition and the second partition are different partitions of the first map data storage device;
a wireless communicator that performs wireless communication with outside;
a difference data storage processing portion that
with the wireless communicator, successively receives update-directed difference data serving as update data for the update-directed data, and
stores the update-directed difference data in the first partition of the first map data storage device where the update-directed data is stored;
an overlap processing portion that performs an overlap process as requested by a process that uses the map data, wherein the overlap process overlaps the update-directed difference data and the update-directed data stored in the first map data storage device; and
an update processing portion that
reads an image file of a second version of the update-directed data newer than the first version from a second map data storage device used in the vehicle and storing the image file of the second version of the update-directed data and an image file of a second version of the update-undirected data,
deletes the first version of the update-directed data and the update-directed difference data stored in the first map data storage device, and
restores the read image file of the second version of the update-directed data to the first partition where the first version of the update-directed data was stored.

3. A map data updating system comprising:
a first map data storage device used in a vehicle and storing map data that includes a first version of update-directed data and a first version of update-undirected data, wherein the update-directed data contains at least road data, wherein the first version of the update-directed data and the first version of the update-undirected data, respectively, are stored in a first partition and a second partition of the first map data storage device, wherein the first partition and the second partition are different partitions of the first map data storage device;
a second map data storage device used in the vehicle and storing an image file of a second version of the update-directed data and an image file of a second version of the update-undirected data, wherein the second version is newer than the first version; and
an update processing device that
reads an image file of the second version of the update-directed data from the second map data storage device, and
restores the read image file of the second version of the update-directed data and overwrites the first partition storing the first version of the update-directed data.
